(19) United States
(12) Patent Application Publication
(10) Pub. No.: US 2026/0111859 A1
(43) Pub. Date: Apr. 23, 2026

(54) BEI x BEIDID x ATMS Sovereign Behavioral-Economic Infrastructure for Identity, Indexing, Currency Mapping, and Clearing

(71) Applicant: FURONG BEI, SAN GABRIEL, CA (US)

(72) Inventor: FURONG BEI, SAN GABRIEL, CA (US)

(21) Appl. No.: 19/353,626

(22) Filed: Oct. 9, 2025

Related U.S. Application Data
(63) Continuation-in-part of application No. 19/074,326, filed on Mar. 8, 2025.
(63) Continuation-in-part of application No. 19/067,845, filed on Mar. 1, 2025.
(63) Continuation-in-part of application No. 19/067,732, filed on Feb. 28, 2025.
(63) Continuation-in-part of application No. 19/072,412, filed on Mar. 6, 2025.
(63) Continuation-in-part of application No. 19/067,907, filed on Mar. 2, 2025.
(63) Continuation-in-part of application No. 19/094,730, filed on Mar. 28, 2025.
(63) Continuation-in-part of application No. 19/056,745, filed on Feb. 19, 2025.
(63) Continuation-in-part of application No. 19/074,352, filed on Mar. 8, 2025.
(63) Continuation-in-part of application No. 19/078,276, filed on Mar. 13, 2025.
(63) Continuation-in-part of application No. 19/076,910, filed on Mar. 11, 2025.
(63) Continuation-in-part of application No. 19/059,110, filed on Feb. 20, 2025, now abandoned.
(63) Continuation-in-part of application No. 19/079,378, filed on Mar. 13, 2025.
(60) Provisional application No. 63/769,143, filed on Mar. 9, 2025.
(60) Provisional application No. 63/769,143, filed on Mar. 9, 2025.
(60) Provisional application No. 63/772,633, filed on Mar. 16, 2025.

(51) Int. Cl. G06Q 20/02; H04L 9/08; H04L 9/32

(52) U.S. Cl. CPC G06Q 20/023; H04L 9/0891; H04L 9/3236; H04L 9/3247; H04L 9/3271; G06Q 2220/123

(57) ABSTRACT

An auditable infrastructure registers sovereign behavioral identities (BEIDID), normalizes behavior events, computes a multi-dimensional Behavioral-Economic Index (BEI), maps the index to fiat currency units using an organic yield model, and settles transactions via a clearing layer (ATMS or BEICX) with exchange (BEIGX) and governance (BEICIVOS) functions. The system includes: an identity layer with dual-signature registration and bounded rollback; a behavior layer producing BEI profiles; a currency layer computing organic yield and BEIUSD, BEICNY, and BEIEUR mappings; a clearing layer with routers enforcing signatures, rollback windows, netting, and audit logs; and publication of civilization indices. Interfaces are standardized and suitable for FRAND licensing with banking systems and regulators.

### CROSS-REFERENCE TO RELATED APPLICATIONS

This application is a continuation of U.S. patent application Ser. No. 19/097,892, filed Apr. 2, 2025, titled “24HWS 24 Human World Systems—The All in One Human Sovereignty Operating System Subtitle Mobile Based Domain Driven Token Enabled.” The specific priority or benefit and relationship will be set forth in the Application Data Sheet (ADS); no claim of priority or benefit is made except as expressly stated in the ADS. In addition, the following commonly owned U.S. applications disclose subject matter related to the present invention and are incorporated by reference only to the extent permitted by 37 C.F.R. Section 1.57; no claim of priority or benefit is made to any of them unless expressly set forth in the ADS: U.S. application Ser. Nos. 19/087,618; 19/169,039 (Conf. 4331); Ser. No. 19/190,738 (Conf. 3187); Ser. No. 19/073,574 (Conf. 4198); Ser. No. 19/086,179 (Conf. 4986); Ser. No. 19/314,019 (Conf. 9034); Ser. No. 19/196,763 (published as US-2025-0259241-A1 on Aug. 14, 2025); and Ser. No. 19/070,527 (Conf. 8251).

### FIELD OF THE INVENTION

The invention relates to digital identity, financial clearing and settlement, and standardizable interfaces linking human behavior to measurable economic value.

### BACKGROUND

Conventional decentralized identity systems identify entities but do not natively bind behavior to regulator-auditable clearing and governance. Cryptocurrency networks produce transferable value but lack verifiable behavioral semantics and governed rollback. There is a need for a sovereign, standardizable infrastructure that ties identity to behavior to index to currency to clearing to governance in a single auditable workflow.

### SUMMARY

Disclosed is a sovereign behavioral-economic infrastructure (SBEI) having six layers (FIG. 1): Identity (100); Behavior (200); Currency (300); Clearing (400); Exchange (500); Governance (600). The identity layer performs dual-signature registration with controlled revocation (FIG. 2). The behavior layer captures events and produces BEI profiles (FIG. 3). The currency layer computes an Organic Yield (OY) and maps BEI to fiat denominations (FIG. 4). The clearing layer records a clearing ledger with routers (FIG. 5). The exchange layer lists behavioral assets, and the governance layer aggregates and publishes a civilization index and executes proposals and votes (FIGS. 6-8). Proof-of-behavior minting is supported (FIG. 9). Typical deployments attach to banking or ATM hubs (FIG. 10).

### BRIEF DESCRIPTION OF THE DRAWINGS

FIG. 1 shows the six-layer architecture (100-600).

FIG. 2 shows BEIDID registration and dual signatures producing IdentityRecord (114) on a distributed ledger (116).

FIG. 3 shows Sensors or APIs (202), a Data Normalizer (204), an Index Calculator (206), and a BEIProfile database (208).

FIG. 4 shows an Organic Yield Calculator (308) mapping BEI to BEIUSD, BEICNY, and BEIEUR.

FIG. 5 shows the global clearing topology with a ClearingLedger (404) and Routers (406).

FIG. 6 shows an Exchange Gateway (502) and a Governance Module (602).

FIG. 7 shows family (702) and industry (704) aggregation.

FIG. 8 shows an Aggregation Engine (802) and a CIVIndex output (804).

FIG. 9 shows BEIMINT proof-of-behavior minting to an Organic Token (908).

FIG. 10 shows a deployment map to banking, clearing, exchange, governance, and currency user interfaces.

### DETAILED DESCRIPTION

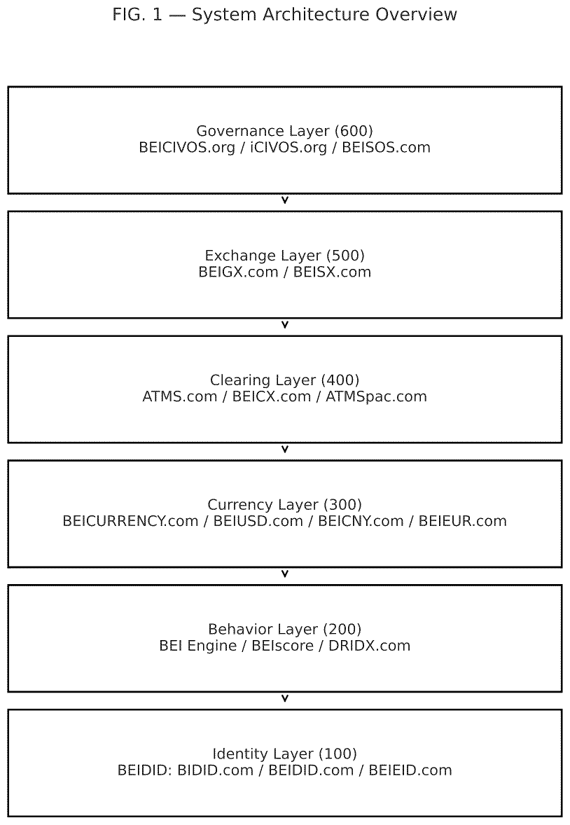

System Architecture (FIG. 1). The system comprises an Identity Layer (100); a Behavior Layer (200); a Currency Layer (300); a Clearing Layer (400); an Exchange Layer (500); and a Governance Layer (600). Each layer exposes standardized APIs; messages are signed, timestamped, and auditable.

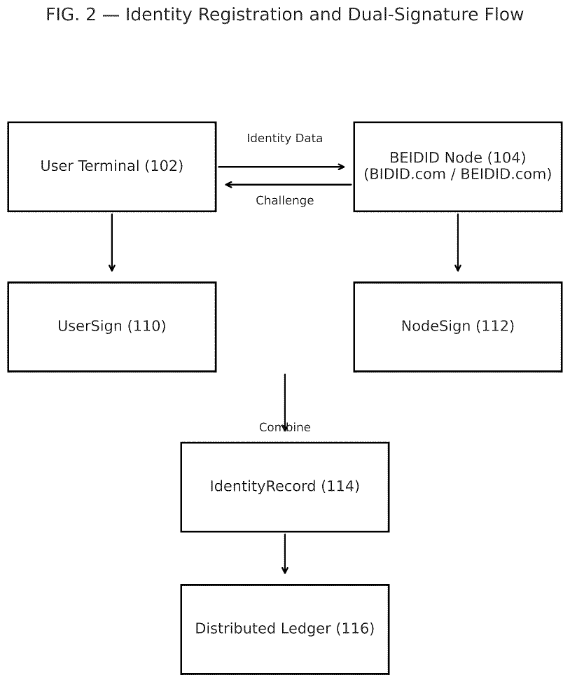

Identity Registration and Authorization (FIG. 2). A user terminal (102) presents public key material to a BEIDID node (104). The node issues a challenge; the user returns a response to produce UserSign (110); the node adds NodeSign (112). The pair yields an IdentityRecord (114), persisted to a distributed ledger (116). A revocation key supports bounded rollback with governance receipts.

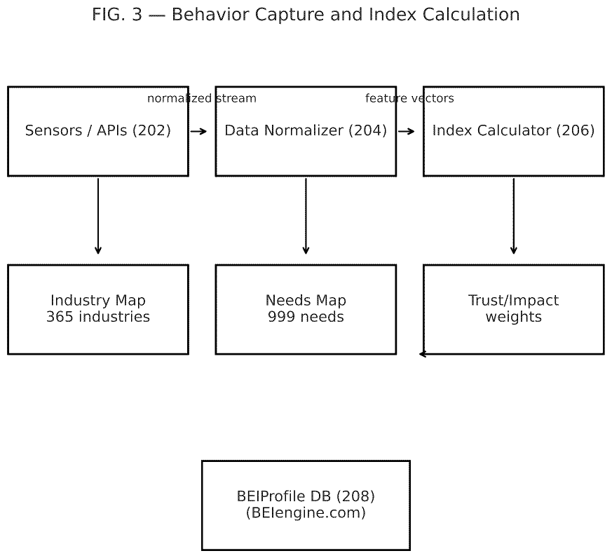

Behavior Capture and Indexing (FIG. 3). Sensors or APIs (202) feed a Data Normalizer (204) that maps events to industry (365) and need classes (999) with trust and impact weights. An Index Calculator (206) updates a BEIProfile database (208) for each identity.

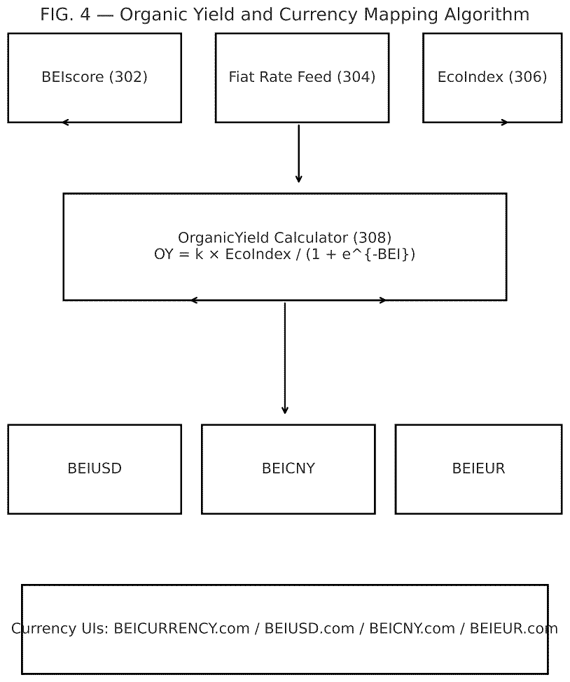

BEI Currency Mapping with Organic Yield (FIG. 4). Inputs include a BEIscore (302), Fiat Rate Feeds (304), and an EcoIndex (306). An Organic Yield Calculator (308) evaluates OY=k*EcoIndex/(1+e\hat{ }(−BEI)) and computes BEIUSD, BEICNY, and BEIEUR. Mappings are exposed to user interfaces. Any domain names appearing herein are illustrative and non-limiting.

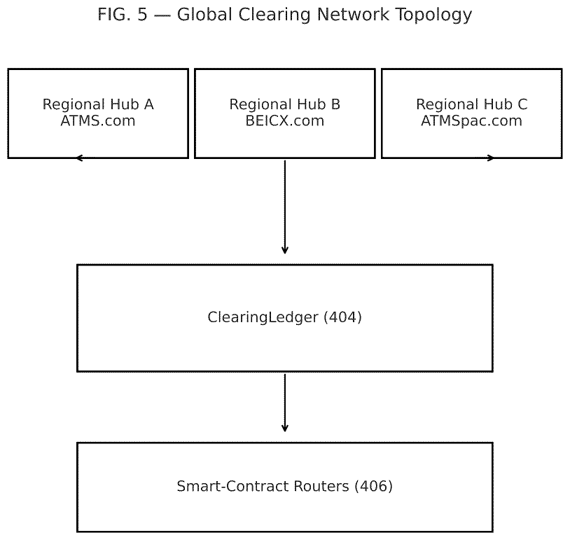

Clearing and Settlement (FIG. 5). Regional hubs, such as ATMS or BEICX, connect through a ClearingLedger (404) with Routers (406) enforcing signature checks, rollback windows, netting, and regulator-grade audit logs. Transactions reference the IdentityRecord (114) and BEI mappings from FIG. 4.

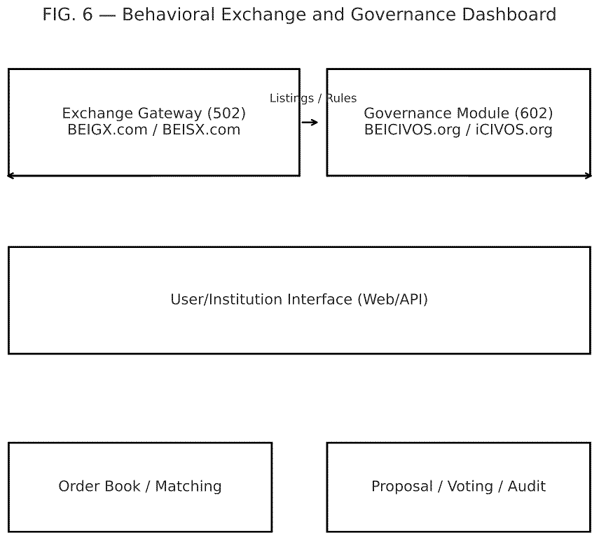

Exchange and Governance (FIG. 6). The Exchange Gateway (502) lists BEI-indexed assets and supports matching. The Governance Module (602) issues proposals, tallies votes, and records governance receipts. Interfaces are suitable for FRAND licensing.

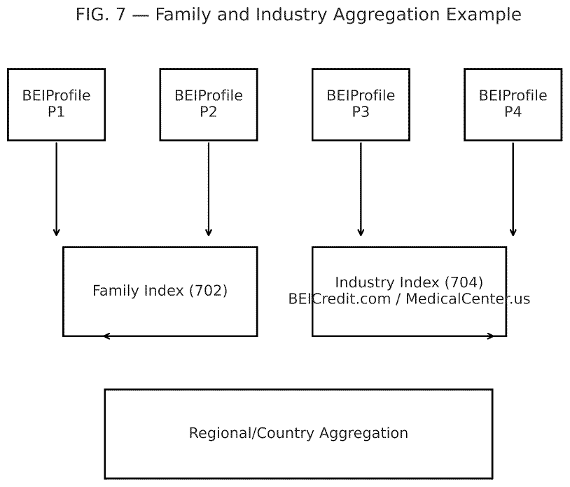

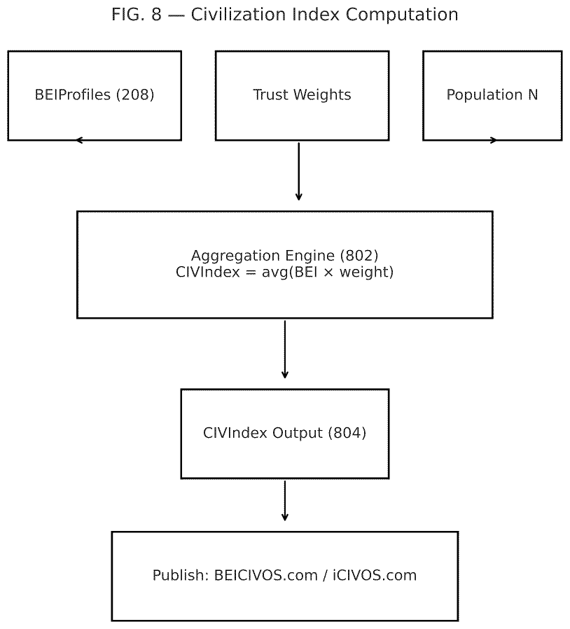

Aggregation and Civilization Index (FIGS. 7-8). BEI profiles aggregate to family indices (702), industry indices (704), and a civilization index via an Aggregation Engine (802) to produce a CIVIndex (804). Publication endpoints expose statistics and regulator dashboards.

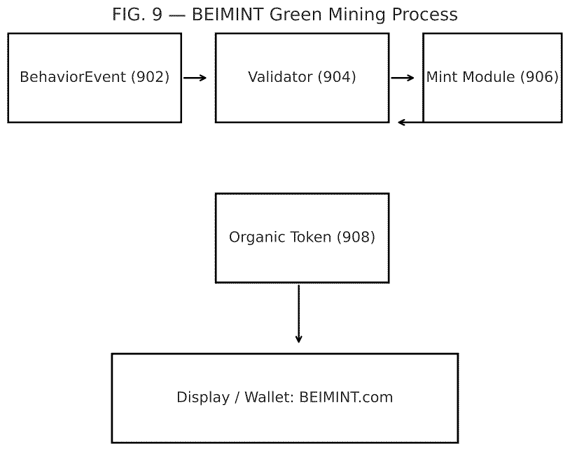

Proof-of-Behavior Minting (FIG. 9). A BehaviorEvent (902) is validated (904) to mint an Organic Token (908) under energy-efficient rules; records inherit audit traits from identity and ledger layers.

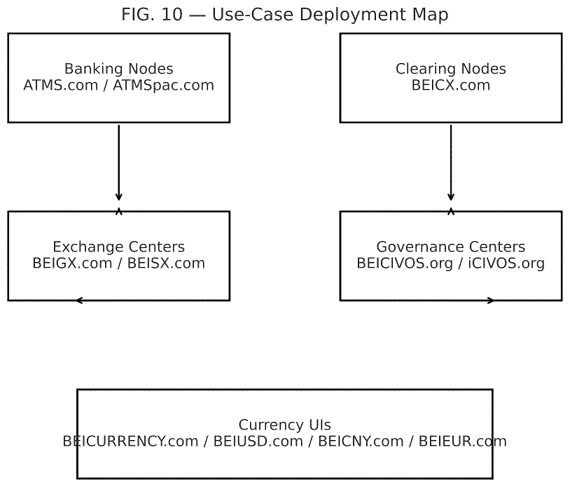

Deployment Example (FIG. 10). Banking nodes (for example, ATMS.com or ATMSpac.com) link to clearing nodes (for example, BEICX.com), exchange centers (for example, BEIGX.com or BEISX.com), governance centers (for example, BEICIVOS.org or iCIVOS.org) and currency UIs (for example, BEICURRENCY.com, BEIUSD.com, BEICNY.com, BEIEUR.com). All domain names are examples only and do not limit the scope.

### ADVANTAGES

The infrastructure (i) binds identity to measurable behavior; (ii) produces a regulator-auditable economic unit (BEI); (iii) maps BEI to fiat with organic yield; (iv) settles via a clearing ledger with governed rollback; and (v) provides standardized interfaces for SEP or FRAND adoption.

What is claimed is:

1. A computer-implemented method for sovereign identity registration and authorization, comprising: receiving, at a node (104), identity material from a user terminal (102); generating, by the node, an identity hash and issuing a cryptographic challenge; producing, by the user terminal, UserSign (110) and, by the node, NodeSign (112) to form a dual-signature package; persisting, by the node, an IdentityRecord (114) to a distributed ledger (116); and enabling controlled revocation using governance receipts within a bounded rollback window; wherein the IdentityRecord is cryptographically linked to at least one BehaviorRecord and at least one ClearingRecord to permit regulator-auditable settlement.

2. A system comprising one or more processors and non-transitory memory storing instructions that, when executed, cause the system to: implement the operations of claim 1; compute a behavioral-economic index (BEI) for an identity from normalized behavior events; evaluate an organic yield according to a sigmoidal function of BEI and an EcoIndex; and expose application programming interfaces configured to provide currency mappings usable by a clearing layer; wherein the system is configured to enforce signature verification, rollback windows, netting, and immutable audit logging.

3. A non-transitory computer-readable medium storing instructions that, when executed by one or more processors, cause a machine to: receive identity material from a user terminal; generate an identity hash and issue a cryptographic challenge; produce a dual-signature package including a user signature and a node signature; persist an identity record to a distributed ledger; compute a behavioral-economic index from normalized behavior events; evaluate an organic yield based on the behavioral-economic index and an EcoIndex; and provide currency mappings usable by a clearing layer.

4. The method of claim 1, wherein revocation uses a threshold-based social recovery key set.

5. The method of claim 1, wherein governance receipts include time-stamped hashes of revocation intent.

6. The method of claim 1, wherein normalizing maps each event to one of 365 industry classes and one of 999 need classes according to a published taxonomy.

7. The method of claim 1, wherein trust and impact weights are dynamically updated from regulator-approved oracles.

8. The method of claim 1, wherein the EcoIndex comprises energy, education, health, and contribution sub-indices combined by a monotone increasing function.

9. The method of claim 1, wherein a BEIProfile (208) is stored on an append-only ledger with zero-knowledge proofs for privacy.

10. The method of claim 1, further comprising minting an Organic Token (908) upon validation of a BehaviorEvent.

11. The system of claim 2, wherein a ClearingLedger (404) supports end-of-day netting and delayed settlement with a rollback window not exceeding a threshold time and records immutable audit hashes for each reversal.

12. The system of claim 2, wherein Routers (406) interoperate with central bank or commercial bank settlement rails.

13. The system of claim 2, wherein an Exchange Gateway (502) lists family or industry indices derived from BEIProfiles.

14. The system of claim 2, wherein a Governance Module (602) tallies proposals with weighted voting tied to BEI trust weights.

15. The method of claim 1, wherein the currency mappings are provided via REST or gRPC application programming interfaces that return BEIUSD, BEICNY, and BEIEUR values with signed response headers.

16. The method of claim 1, wherein the BEIscore is used by credit or insurance modules to compute behavior-based credit limits.

17. The system of claim 2, wherein regulator dashboards publish the CIVIndex (804) and anomaly alerts.

18. The method of claim 1, wherein identity hashing combines public keys, sovereign credentials, and time to form a unique identity hash.

19. The system of claim 2, wherein exchange and governance records are linked with governance receipts to form a complete audit trail.

20. The method of claim 1, wherein mapping coefficients are learned by machine-assisted calibration subject to regulator constraints.
